(19) United States
(12) Patent Application Publication
(10) Pub. No.: US 2009/0040325 A1
(43) Pub. Date: Feb. 12, 2009

(54) Methods for remote imaging and systems thereof

(76) Inventors: Thomas C. Beecher, JR., Richmond, VA (US); Robert W. Putterman, Asheville, NC (US)

Correspondence Address: NIXON PEABODY LLP - PATENT GROUP, 1100 CLINTON SQUARE, ROCHESTER, NY, 14604, US

(21) Appl. No.: 11/891,136

(22) Filed: Aug. 9, 2007

(51) Int. Cl. H04N 5/235

(52) U.S. Cl. 348/221.1; 348/E05.034

(57) ABSTRACT

Methods and systems for remote imaging include providing in substantially real time one or more images of an object captured with an imaging system to one or more client systems at one or more locations remote from the imaging system. In substantially real time, one or more instructions to interact with the imaging system are received from at least one of the client systems. In response to the instructions, one or more operations are executed at the imaging system and one or more updated images are provided to the client systems in response to the execution of the operations.

### FIELD OF THE INVENTION

The present invention generally relates to systems and methods for imaging and, more particularly, to methods for remote imaging and systems thereof.

### BACKGROUND

There is a strong incentive to engineer ways in which taxonomy can be accelerated. Rapid environmental changes, introductions of foreign species, and threats of biological terrorism are exacerbating society's need to make accurate identifications of an increasingly global fauna and flora. Insects are integral components of most terrestrial and freshwater ecosystems and include vectors of disease, agricultural pests, invasive species, and offer enormous insight into the evolutionary and biogeographic history of earth. Accurate identifications of many of the existing 925,000 species of insects require access to reference or type specimens or an expert. Considering that three-quarters of living insect species remain undescribed, new tools are needed to expedite the work of descriptive taxonomy and identification work.

The relative inaccessibility of specimens of tens of thousands of insect species has become a serious bottleneck to the flow of essential information. Taxonomic research, including descriptions of new species and corroboration of existing species, is slowed by the frequent requirement to make comparisons with rare or type specimens. Until now, entomologists have had only two choices. Either visit a relevant collection to make comparisons on sight or request to borrow fragile and extremely rare material through loans shipped at great risk. Both require significant effort and time and prohibit immediate answers to sometimes pressing questions, such as determining the status of specimens intercepted at a port of entry.

Prior efforts have focused on making existing data associated with specimens in a digital format and readily available. This has already spawned exciting new ways to analyze and understand diversity and distribution of species, but stops short of making the specimens themselves available. Similarly impressive efforts have been made to create digital libraries of type specimens. Unfortunately, these sites typically have only a few fixed-angle views of specimens that may or may not capture the salient characters needed by experts or other users.

### SUMMARY

A method for remote imaging in accordance with embodiments of the present invention includes providing in substantially real time one or more images of an object captured with an imaging system to one or more client systems at one or more locations remote from the imaging system. In substantially real time, one or more instructions to interact with the imaging system are received from at least one of the client systems. In response to the instructions, one or more operations are executed at the imaging system and one or more updated images are provided to the client systems in response to the execution of the operations.

A computer readable medium having stored thereon instructions for remote imaging comprising machine executable code in accordance with other embodiments of the present invention includes providing in substantially real time one or more images of an object captured with an imaging system to one or more client systems at one or more locations remote from the imaging system. In substantially real time, one or more instructions to interact with the imaging system are received from at least one of the client systems. In response to the instructions, one or more operations are executed at the imaging system and one or more updated images are provided to the client systems in response to the execution of the operations.

A system for remote imaging in accordance with other embodiments of the present invention includes an imaging system that captures one or more images of an object, a transceiver system, and an image processing system. The transceiver system in substantially real time provides the images to one or more client systems at one or more remote locations and receives from at least one of the client systems one or more instructions to interact with the imaging system. The image processing system executes one or more operations at the imaging system in response to the instructions. The transceiver system provides one or more updated images to the client systems in response to the execution of the operations.

A method for remotely focusing an imaging system in accordance with other embodiments of the present invention includes superimposing a favorite image over a selected image. One of the superimposed images is selected based on a comparison of one or more aspects of the favorite image and the selected image. A focus of the imaging system is set based on one or more settings used for capturing the selected one of the superimposed images.

A system for remotely focusing an imaging system in accordance with other embodiments of the present invention includes a display system, a selection system, and a focus adjustment system. The display system superimposes and enables manipulation of a favorite image over a selected image. The selection system selects one of the superimposed images based on a comparison of one or more aspects in the favorite image and the selected image. The focus adjustment system sets a focus of an imaging system based on one or more settings used for capturing the selected one of the superimposed images.

The present invention provides a number of advantages including providing methods and systems for examining, manipulating, and capturing high resolution images of specimens from remote locations. With the present invention, museums and other research entities can form a distributed, virtual research infrastructure of unprecedented comprehensiveness. The present invention will enable researchers in multiple institutions to collaborate in taxonomic investigations, speeding the processes of discovering new species and critically testing those already known to science.

With the present invention, specimens previously too rare to be borrowed and not in readily accessible locations can now be shared with ease. The present invention enables taxonomy specialists and other operators from anywhere in the world to use their expertise to examine, manipulate, and acquire images of specimens at precisely the right angle to show characters of key importance to evolutionary or taxonomic studies. Further, the present invention provides an effective mechanism for focusing an imaging system from a remote location.

### BRIEF DESCRIPTION OF THE DRAWINGS

FIG. 1 is a block diagram of a system for remote imaging in accordance with embodiments of the present invention;

FIG. 2 is a flowchart of a method for registering and authenticating an operator for the system for remote imaging;

FIG. 3 is a flowchart of a method for managing scheduled appointments in the system for remote imaging; and

FIG. 4 is a flowchart of a method for managing imaging operations in the system for remote imaging.

### DETAILED DESCRIPTION

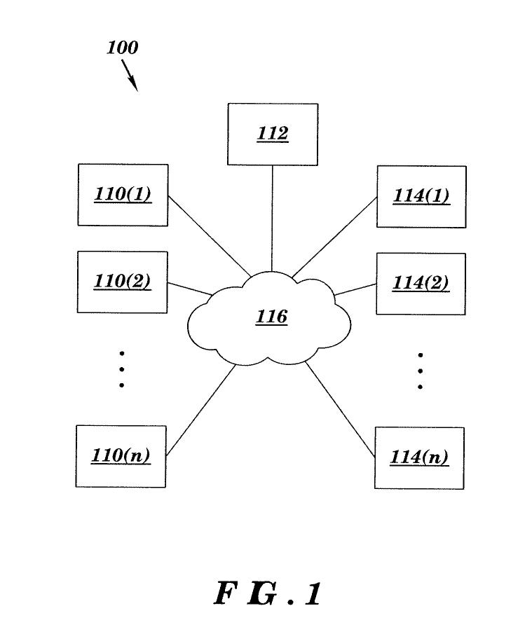

A system 100 for remote imaging in accordance with embodiments of the present invention is illustrated in FIG. 1. The system 100 includes remotely operable microscope systems 110(1-n), an imaging management system 112, user computing systems 114(1-n), and a communication system 116, although the system 100 can include other types and numbers of components, devices, and/or systems configured in other manners. The present invention provides a number of advantages including providing an effective, efficient, and easy to use method and system for examining, manipulating, and capturing high resolution images of specimens with imaging systems at remote locations.

Referring more specifically to FIG. 1, the remotely operable microscope systems 110(1-n) are used to view and examine specimens stored at their remote locations, although other types and numbers of imaging systems which are used for other types and numbers of functions can be used. By way of example only, the remotely operable microscope systems 110(1-n) could be at remote locations, such as: USDA, Systematic Entomology Laboratory, Beltsville. Md.; Natural History Museum, London, England; Museum National d'Histoire Naturelle, Paris, France; Smithsonian Institution, Washington D.C.; American Museum of Natural History, New York, N.Y.; Museum of Comparative Zoology, Cambridge, Mass.; Field Museum of Natural History, Chicago, Ill.; California Academy of Sciences, San Francisco, Calif.; Bishop Museum, Honolulu, Hi.; and IISE, Arizona State University, Tempe, Ariz. In this particular example, the specimens being examined are insects, although other types of objects at remote locations could be examined. In this example, the remotely operable microscope systems 110(1-n) are designed to meet the needs of operators working with dry mounted (pinned) and microscope system slide-mounted specimens, although the imaging systems can be designed for other types and numbers of operations with other types and numbers of objects being examined.

Each of the remotely operable microscope systems 110(1-n) includes an imaging unit for capturing one or more images of the specimen, such as one or more still pictures or video, a lighting system for providing varying amounts of light on the specimen for imaging, an aperture positioned and operable to control the light from the lighting system on to the specimen, a position adjustment system to move the specimen to other positions, a zoom control system, a focusing system, and a microscope control system, although each of the remotely operable microscope systems 110(1-n) could comprise other numbers and types of components, devices, and image control systems and in other configurations. The microscope control system controls the operation of the remotely operable microscope system and includes a central processing unit (CPU) or processor, a memory, an interface system, a user input system, and a display system which are coupled together by a bus or other link, although other numbers and types of each of the components and other configurations and locations for the components can be used. The processor in each of the remotely operable microscope systems 110(1-n) executes a program of stored instructions for one or more aspects of the present invention as described herein, including for remote imaging operations. The memory stores these programmed instructions for one or more aspects of the present invention as described herein, although some or all of the programmed instructions could be stored and/or executed elsewhere. A variety of different types of memory storage remotely operable microscope systems, such as a random access memory (RAM) or a read only memory (ROM) in the system or a floppy disk, hard disk, CD ROM, DVD ROM, or other computer readable medium which is read from and/or written to by a magnetic, optical, or other reading and/or writing system that is coupled to the processor, can be used for the memory. The interface system in each of the remotely operable microscope systems 110(1-n) is used to operatively couple and communicate between each of the remotely operable microscope systems 110(1-n) and the imaging management system 112 and the user computing systems 114(1-n) via the communication system 116, although other numbers and types of connections to other devices and systems and communication methods could be used.

The user input device in each of the remotely operable microscope systems 110(1-n) is used to input data, such as the bounding box region for each particular specimen which is being examined, although other types of data could be input. The user input device comprises a computer keyboard and a computer mouse, although other types and numbers of user input devices can be used. The display system in each of the remotely operable microscope systems 110(1-n) is used to show data and information to the user at each of the remotely operable microscope systems 110(1-n), such as the identity of the specimen and the defined bounding region in three dimensions by way of example only. The display system comprises a computer display screen, such as a CRT or LCD screen by way of example only, although other types and numbers of displays could be used, such as a printer.

The imaging management system 112 is responsible for monitoring and controlling one or more operation and functions of the remotely operable microscope systems 110(1-n) as described herein based on interactions with and instructions from the remotely operable microscope systems 110(1-n) and the user computing systems 114(1-n), although other types and numbers of operations and functions can be carried out by the imaging management system 112. The imaging management system 112 includes a central processing unit (CPU) or processor, a memory, and an interface system which are coupled together by a bus or other link, although other numbers and types of each of the components and other configurations and locations for the components can be used. The processor in the imaging management system 112 executes a program of stored instructions for one or more aspects of the present invention as described herein, including for remote imaging operations. The memory stores these programmed instructions for one or more aspects of the present invention as described herein, although some or all of the programmed instructions could be stored and/or executed elsewhere. A variety of different types of memory storage devices, such as a random access memory (RAM) or a read only memory (ROM) in the system or a floppy disk, hard disk, CD ROM, DVD ROM, or other computer readable medium which is read from and/or written to by a magnetic, optical, or other reading and/or writing system that is coupled to the processor, can be used. The interface system in the imaging management system 112 is used to operatively couple and communicate between the imaging management system 112 and the remotely operable microscope systems 110(1-n) and the user computing systems 114(1-n) via the communication system 116 during the execution of the operations and functions as described herein, although other numbers and types of connections to other devices and systems and communication methods could be used.

Each of the user computing systems 114(1-n) enables a user or operator to establish a communication with one or more of the remotely operable microscope systems 110(1-n) and to examine, manipulate, and capture one or more images of one or more specimens using the one or more of the remotely operable microscope systems 110(1), although the user computing systems 114(1-n) could be used by an operator for other types and numbers of operations. Each of the user computing systems 114(1-n) includes a central processing unit (CPU) or processor, a memory, an interface system, a user input system, and a display system which are coupled together by a bus or other link, although each of the user computing systems 114(1-n) can comprise other numbers and types of components and systems in other configurations. The processor in each of the user computing systems 114(1-n) executes a program of stored instructions for one or more aspects of the present invention as described and illustrated herein, including for remote imaging operations, although the processor could execute other types of programmed instructions. The memory in each of the user computing systems 114(1-n) stores these programmed instructions for one or more aspects of the present invention as described herein, although some or all of the programmed instructions could be stored and/or executed elsewhere. A variety of different types of memory storage devices, such as a random access memory (RAM) or a read only memory (ROM) in the system or a floppy disk, hard disk, CD ROM, or other computer readable medium which is read from and/or written to by a magnetic, optical, or other reading and/or writing system that is coupled to one of the processor, can be used for the memory. The interface system in each of the user computing systems 114(1-n) is used to operatively couple and communicate between each of the user computing systems 114(1-n) and the remotely operable microscope systems 110(1-n) and the imaging management system via the communication system 116, although other numbers and types of connections to other devices and systems and communication methods could be used.

The user input device in each of the user computing systems 114(1-n) is used to input selections, such as which of the remotely operable microscope systems 110(1-n) are being selected and run, although other types of data could be input. The user input device comprises a computer keyboard and a computer mouse, although other types and numbers of user input devices can be used. The display system in each of the user computing systems 114(1-n) is used to show data and information to the user, such as video and/or images of specimens obtained at one or more of the remotely operable microscope systems 110(1-n), although other types of data and information could be displayed and other manners of providing the information can be used. The display system comprises a computer display screen, such as a CRT or LCD screen by way of example only, although other types and numbers of displays could be used, such as a printer.

The communications network 116 comprises the Internet, although other types and numbers of communication systems, such as a direct connection, a local area network, a wide area network, modems and phone lines, e-mails, and/or wireless communication technology each having their own communications protocols, in other configurations could be used. With respect to the locations of one or more of the remotely operable microscope systems 110(1-n) with respect to one or more of the user computing systems 114(1-n), a variety of different types of spatial arrangements can be used. By way of example only, they could be on opposing sides of the same room, in different rooms, on different floors, in different buildings, and in different parts of the world.

Although an example of embodiments of the remotely operable microscope systems 110(1-n), the imaging management system 112, and the user computing systems 114(1-n), are described and illustrated herein, each could be implemented on any suitable device or system. It is to be understood that the devices and systems of the exemplary embodiments are for exemplary purposes, as many variations of the specific hardware and software used to implement the exemplary embodiments are possible, as will be appreciated by those skilled in the relevant art(s).

Furthermore, each of the devices and systems of the present invention may be conveniently implemented using one or more general purpose computer systems, microprocessors, digital signal processors, micro-controllers, and the like, programmed according to the teachings of the present invention as described and illustrated herein, as will be appreciated by those skilled in the computer and software arts.

In addition, two or more computing devices or systems can be substituted for any one of the devices or systems in any embodiment of the present invention. Accordingly, principles and advantages of distributed processing, such as redundancy, replication, and the like, also can be implemented, as desired, to increase the robustness and performance the devices and systems of the exemplary embodiments. The present invention may also be implemented on one or more of any devices, systems or servers that extend across any network using any suitable interface mechanisms and communications technologies including, for example telecommunications in any suitable form (e.g., voice, modem, and the like), wireless communications media, wireless communications networks, cellular communications networks, G3 communications networks, Public Switched Telephone Network (PSTNs), Packet Data Networks (PDNs), the Internet, intranets, a combination thereof, and the like.

The present invention may also be embodied as a computer readable medium having instructions stored thereon for predictive capacity planning as described herein, which when executed by a processor, cause the processor to carry out the steps necessary to implement the methods of the present invention as described and illustrated herein.

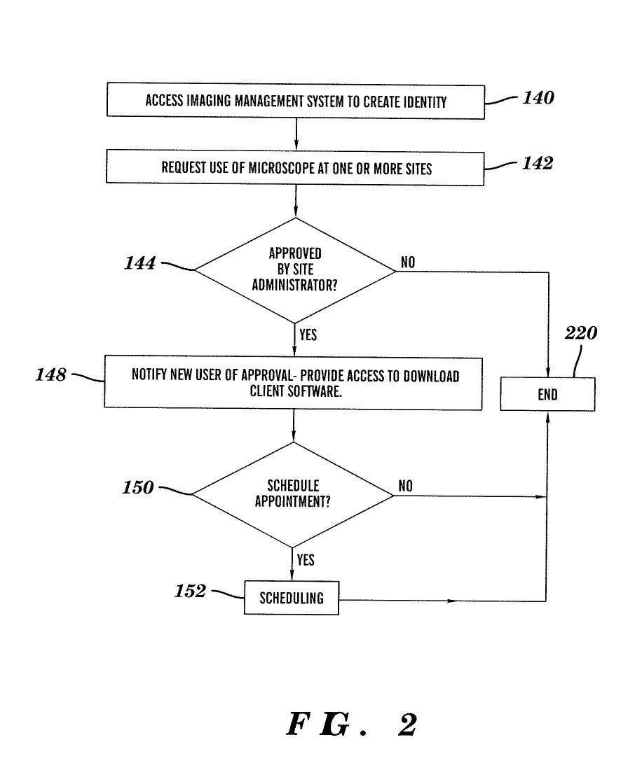

The operation of the system for remote imaging in accordance with embodiments of the present invention will now be described with reference to FIGS. 1-4. Referring specifically to FIG. 2, in step 140 an operator at one of the user computing systems 114(1-n) will access and interact with the imaging management system 112 to create a login and password identity which is then entered into a database stored in memory in the imaging management system 112, although other manners for registering operators can be used. During this registration process, the requesting operator at one of the user computing systems 114(1-n) inputs the reason or reasons for using the system 100 and acknowledges compliance with one or more required conditions for using the system 100, although other types and numbers of registration procedures which are carried at this or other locations could be used.

Next, in step 142 the operator at one of the user computing systems 114(1-n) requests permission from the imaging management system 112 to use of one or more of the remotely operable microscope systems 110(1-n), although other manners and systems or other entities for determining if access will be granted can be used. The imaging management system 112 may also require acknowledgement of compliance with one or more additional conditions associated with the requested one or more remotely operable microscope systems 110(1-n).

In step 144, the imaging management system determines based on the login and password identity received from the operator at one of the user computing systems 114(1-n) and, if appropriate, receipt of acknowledgement of compliance with the one or more additional conditions, whether or not to approve access, although other manners for determining approval can be used. This approval process may be automated or be conducted manually by one or more administrators who review the request from the operator at one of the user computing systems 114(1-n). Additionally, these requests may be individually approved or disapproved on a location-by-location basis. By way of example only, an operator 114(1-n) may be approved for one of the remotely operable microscope systems 110(1-n) at one location, but not approved for one at another location. Once the approval or disapproval has been determined, the decision is stored in a database in memory in the imaging management system 112. If access is not approved for any of the remotely operable microscope systems 110(1-n) in step 144, then the requesting operator at one of the user computing systems 114(1-n) is notified of the disapproval and the No branch is taken to step 220 where this part of the operation ends. If access is approved for one or more of the remotely operable microscope systems 110(1-n) in step 144, then the Yes branch is taken to step 148.

In step 148 the requesting operator at one of the user computing systems 114(1-n) is notified of the approval for each request. Additionally, for the one or more of the remotely operable microscope systems 110(1-n) for which approval was granted, the accompanying instructions, software, and/or other information necessary to use the approved one or more of the remotely operable microscope systems 110(1-n) is downloaded from the imaging management system 112 to the one of the user computing systems 114(1-n) making the request, although the instructions, software, and/or other information could be stored and transmitted from other locations to the one of the user computing systems 114(1-n) making the request.

Next, in step 150 an operator at one of the user computing systems 114(1-n) can submit a request for a time and date for using one or more of the remotely operable microscope systems 110(1-n) to the imaging management system 112, although other manners and information can be used for scheduling appointments. If no request for scheduling an appointment is received in step 150, then the No branch is taken to step 220 where this part of the operation ends. If a request for scheduling an appointment is received in step 150, then the Yes branch is taken to step 152.

In step 152, the imaging management system 112 processes the request for scheduling an appointment with one or more of the remotely operable microscope systems 110(1-n), although the requests for scheduling appointments can take place at other locations and other times and be managed by other systems, such as at each of the remotely operable microscope systems 110(1-n). The imaging management system 112 or other system managing the scheduling may prioritize the scheduling of appointments based on one or more factors. By way of example only, factors which may influence the prioritization of a request for an appointment include: (a) applications that facilitate and illustrate the positive impacts of collaborative taxonomy practiced between institutions, cities, and countries; (b) applications that facilitate rapid identifications of species that present potential threats to the United States, such as potential major pests and vectors of disease; (c) applications that meet urgent needs for identifications by ecologists or other environmental researchers; (d) applications that make specimens available for educational goals; (e) access to students and researchers at institutions, including predominantly minority higher education institutions, that lack large research collections; (f) access to students and colleagues in developing nations for which many or most relevant specimens are housed in U.S. collections; (g) applications that demonstrate value of instruments in public outreach, such as large plasma displays in public spaces or public lectures; (h) applications that bring museums to life for students at formative ages (especially K-12), demonstrating the rich information content of collections to students who might consider careers in science. The imaging management system 112 receives the submitted requests and then coordinates and confirms the scheduling of the appointment with the requesting operator at one of the user computing systems 114(1-n). Once an appointment is scheduled, the operation moves to step 220 where this part of the operation ends.

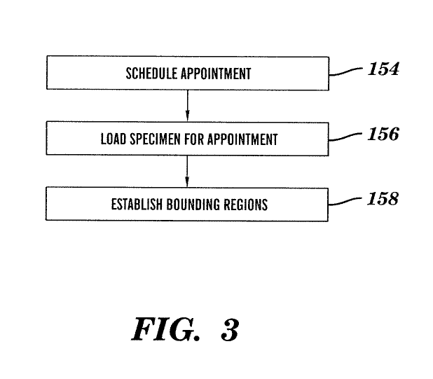

Referring to FIG. 3, in step 154 one or more key operators at each of the remotely operable microscope systems 110(1-n) monitor and manage the scheduled appointments at each of the remotely operable microscope systems 110(1-n), although other manners for monitoring for and managing the schedule appointments can be used, such as with an automated system. A key operator is someone who is authorized to operate the requested one of the remotely operable microscope systems 110(1-n) at the remote location.

In step 156, before the schedule date and time for an appointment, a key operator at the one of the remotely operable microscope systems 110(1-n) with the scheduled appointment, receives information on the appointment and the desired specimen, such as a particular pinned insect or a slide with a portion of a particular insect by way of example. The key operator at the one of the remotely operable microscope systems 110(1-n) will obtain and load the requested specimen before the date and time for the scheduled appointment, although other manners for loading the requested specimens could be used, such as an automated loading system which could automatically load one or more specimens, and other types of objects could be loaded.

In step 158, the key operator at the one of the remotely operable microscope systems 110(1-n) with the loaded specimen also enters a three dimensional bounding region around the specimen, although other manners for establishing the bounding region with other dimensions and properties can be used. By way of example only, the bounding region for the loaded specimen could be automatically retrieved from memory in the requested one of the remotely operable microscope systems 110(1-n) or from another storage location and transmitted to the imaging management system 112 to restrict the operations of the user at one of the user computing systems 114(1-n) authorized to examine and manipulate the specimen. The bounding region around the loaded specimen defines a protective area which can not be entered during the examination, manipulation, or imaging to prevent damaging the loaded specimen while executing one or more instructions from the operator at one of the user computing systems 114(1-n).

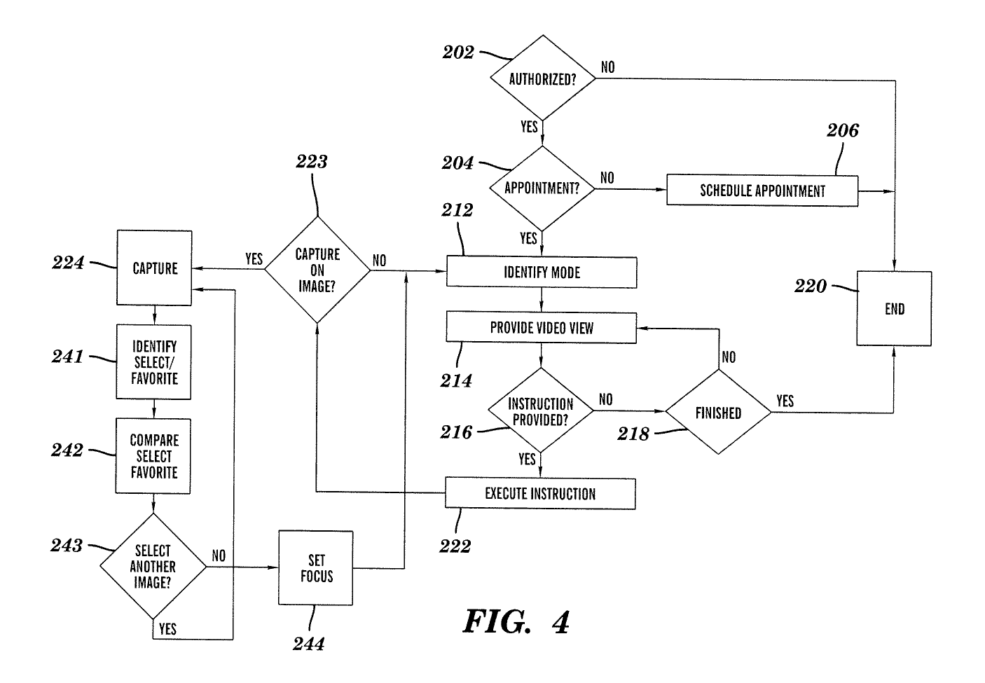

Referring to FIG. 4, in step 202 an operation for remote imaging can be initiated by an operator or operators at one or more of the user computing systems 114(1-n). The operator at one or more of the user computing systems 114(1-n) each enter a login name and password which is transmitted to the imaging management system 112 for authentication, although other types and amounts of information could be entered by the operator. The imaging management system 112 compares the entered login name and password against a database of authorized login names and passwords stored in the memory of the imaging management system 112 to determine if the operator is authorized to use the system 100 and the extent of that authorization, although other types and numbers of authentication procedures which are carried out at this or other locations could be used. As explained herein, the operator may only be authorized to view captured images, but not control any operations or functions of the remotely operable microscope systems 110(1-n). Typically, only one operator will have control authorization to provide instructions to examine, manipulate, and image the specimen and perform other operations, such as selecting the mode.

If the imaging management system 112 determines the requesting operator at one of the user computing systems 114(1-n) is not authorized, then in step 202 the No branch is taken to step 220 where this part of the operation ends. If the imaging management system 112 determines the requesting operator at one of the user computing systems 114(1-n) is authorized, then in step 202 the Yes branch is taken to step 204.

In step 204, the time and date entered by the authorized operator or operators at one or more of the user computing systems 114(1-n) for using one of the remotely operable microscope systems 110(1-n) is compared by the imaging management system 112 against a stored calendar of appointments for the requested one of the remotely operable microscope systems 110(1-n), although other types and amounts of scheduling information could be entered by the operator and other manners for determining if the request is during a scheduled period could be used. If the imaging management system 112 determines the requesting operator at one of the user computing systems 114(1-n) does not have a current appointment for the requested one of the remotely operable microscope systems 110(1-n), then in step 204 the No branch is taken to step 206.

In step 206, the requesting operator at one of the user computing systems 114(1-n) can submit a request for a time and date for using one or more of the remotely operable microscope systems 110(1-n) to the imaging management system 112 as described in greater detail earlier with reference to FIG. 2, although other manners and information can be used for scheduling appointments. The imaging management system 112 receives the submitted requests and then coordinates and confirms the scheduling of the appointment with the requesting operator at one of the user computing systems 114(1-n). Once an appointment is scheduled, the operation moves to step 220 where this part of the operation ends until the operator at one of the user computing systems 114(1-n) tries to initiate the process again.

Referring back to step 204, if the imaging management system 112 determines the requesting operator or operators at one or more of the user computing systems 114(1-n) do have a current appointment for the requested one of the remotely operable microscope systems 110(1-n), then in step 204 the Yes branch is taken to step 212 to allow communications between the authorized operator at the one of the user computing systems 114(1-n) and the requested one of the remotely operable microscope systems 110(1-n).

In step 212, the operator at the one of the user computing systems 114(1-n) authorized to examine and manipulate the loaded specimen selects a mode for interacting with the specimen, although other manners for providing the mode can be used. In this particular embodiment, the operator can select from a macro mode, a micro mode and a label mode, although other numbers and types of modes could be used. The macro mode allows an operator at the authorized one of the user computing systems 114(1-n) to manipulate, examine, and capture images of a specimen from any view desired by the operator, although the macro mode could allow for other types and numbers of operations. The micro mode allows an operator at the authorized one of the user computing systems 114(1-n) to view specimen on a slide and to adjust an aperture under a light source for the one of the remotely operable microscopes 110(1-n), although the micro mode could allow for other types and numbers of operations. The label mode allows an operator at the authorized one of the user computing systems 114(1-n) to view and capture an image of the label for the specimen being viewed, although the label mode could allow for other types and numbers of operations.

In step 214, the requested one of the remotely operable microscope systems 110(1-n) provides one or more video views of the specimen to the one or more of the user computing systems 114(1-n) with the authorized operators for viewing the captured and provide images as described herein, although other types of images can be provided, such as still images. The imaging management system 112 adjusts a video fame rate based on the bandwidth to control the rate at which images are provided between the requested one of the remotely operable microscope systems 110(1-n) and the one or more of the authorized user computing systems 114(1-n), although other manners for adjusting an amount of data which is transmitted can be used.

In step 216, the imaging management system 112 determines if the one of the of the user computing systems 114(1-n) with the authorized operator with control for examining and manipulating the specimen has provided an instruction or instructions for any operations to the requested one of the remotely operable microscope systems 110(1-n). If the imaging management system 112 determines this one of the of the user computing systems 114(1-n) has provide an instruction or instructions for any operations, then a Yes branch in taken to step 222. If the imaging management system 112 determines that this user computing systems 114(1-n) has not provide an instruction or instructions for any operations for a set period of time or the instruction is received from an authorized operator without control, such as a student who can just view the images, at another one of the user computing systems 114(1-n), then a No branch in taken to step 218.

In step 218, the imaging management system 112 determines if this particular examination is finished based on the period of inactivity and if the time period for the scheduled appointment has expired, although other types and numbers of factors can be evaluated to determine if the examination is finished, such as a request from the authorized operator at one of the of the user computing systems 114(1-n) for examining and manipulating the specimen to end the process. If the imaging management system 112 determines this particular examination is completed, then the Yes branch is taken to step 220 where this operation ends. If the imaging management system 112 determines this particular examination is not completed, then the No branch is taken back to step 214 as described earlier.

Referring to step 222, the instruction or instructions from the authorized operator at one of the of the user computing systems 114(1-n) are executed at the requested one of the remotely operable microscope systems 110(1-n). A variety of different types of instructions could be executed at the requested one of the remotely operable microscope systems 110(1-n). By way of example only, an instruction could be executed at the requested one of the remotely operable microscope systems 110(1-n) to: switch between the macro, micro, and label modes; to control an aperture of light from a light source requested one of the remotely operable microscope systems 110(1-n); adjust the restriction to receive the instructions from one or more currently authorized operator(s) without control at another one(s) of the user computing systems 114(1-n); authorize one or more operators at other user computing systems 114(1-n) to view the images and take part in any discussion regarding the images; adjust lighting of the specimen from the lighting system at the requested one of the remotely operable microscope systems 110(1-n); adjust one or more image control systems of the requested one of the remotely operable microscope systems 110(1-n); manipulate the object to at least one other position with the position adjustment system or other device at the requested one of the remotely operable microscope systems 110(1-n); display the other participants viewing the provided image or images of the specimen; and adjust a focus of the requested one of the remotely operable microscope systems 110(1-n), although other types and numbers of instructions could be executed.

In step 223, the authorized operator at one of the user computing system 114(1-n) with control determines whether or not to capture an image with the one of the remotely operable microscope systems 110 (1-n) currently under control to adjust the focus, although other techniques for focusing can be used. If an image is not going to be captured to adjust the focus, then the No branch in step 223 is taken back to step 212 as described earlier. If an image is going to be captured to adjust the focus, then the Yes branch in step 223 is taken to step 224.

In step 224, the authorized operator utilizing one of the user computing systems 114(1-n) captures images with the one or more remotely operable microscope system 110 (1-n) under control. The captured images are transmitted to and displayed on the user computing systems 114(1-n) utilized by all authorized users of the remotely operable microscope system 110 (1-n) for viewing and discussion purposes.

In step 241 the operator at one of the user computing systems 114(1-n) with authority to control the remotely operable microscope system 110 (1-n) identifies one favorite image and one selected image. Next, the one of the user computing systems 114(1-n) utilized by the authorized operator superimposes the selected and favorite images and displays the images on the display device for that one of the user computing systems 114(1-n).

In step 242, the operator at the one of the user computing systems 114(1-n) with authority to control the remotely operable microscope system 110 (1-n) can manipulate the edges of the superimposed images so all or portions of each of the images are visible. This authorized operator can compare the superimposed images for a variety of different aspects, including by way of example only focus, depth of field, lighting, cropping and other factors important to the specific specimen. The authorized operator at the one of the user computing systems 114(1-n) compares one or more aspects and then selects a current favorite image from the prior favorite image and the selected image.

Next, in step 243 the operator at the one of the user computing systems 114(1-n) with authority to control the remotely operable microscope system 110 (1-n) determines whether another image should be selected. If the authorized operator determines another image is required, then the Yes branch is taken back to step 224 as described above and the process is repeated. If the authorized operator determines another image is not required, then the No branch is taken to step 244.

In step 244, the focus at the requested one of the remotely operable microscopes 110(1-n) is then set based on the settings used to capture the current favorite image. This process for focusing the requested one of the remotely operable microscopes 110(1-n) avoids the problem of delays between fine tuning instructions sent to remote imaging systems and the image capture, transmission, and display of the results of those instructions on the captured images based on those fine tuning instructions. Typically, this response rate to fine tuning instructions is to slow to provide an effective and efficient manner for focusing the requested one of the remotely operable microscopes 110(1-n). Once the focus is set in step 244, the operation proceeds back to step 212 as described earlier.

Accordingly, the present invention provides an effective, efficient, and easy to use method and system for examining, manipulating, and capturing high resolution images of specimens with imaging systems at remote locations. With the present invention, invention, specimens previously too rare to be borrowed and not in readily accessible locations can now be shared with ease. The present invention enables operators from anywhere in the world to use their expertise to examine, manipulate, and acquire images of specimens at precisely the right angle. Further, the present invention provides an effective mechanism for focusing an imaging system from a remote location.

Having thus described the basic concept of the invention, it will be rather apparent to those skilled in the art that the foregoing detailed disclosure is intended to be presented by way of example only, and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations therefore, is not intended to limit the claimed processes to any order except as may be specified in the claims. Accordingly, the invention is limited only by the following claims and equivalents thereto.

What is claimed is:

1. A method for remote imaging, the method comprising:
providing in substantially real time one or more images of an object captured with an imaging system to one or more client systems at one or more locations remote from the imaging system;
receiving in substantially real time from at least one of the client systems one or more instructions to interact with the imaging system; and
executing one or more operations at the imaging system in response to the instructions, wherein the providing provides one or more updated images to the client systems in response to the execution of the operations.

2. The method as set forth in claim 1 further comprising receiving a dynamically established bounding region around the object, wherein the executing the one or more instructions is constrained by the bounding region.

3. The method as set forth in claim 2 wherein the bounding region is defined in three dimensions.

4. The method as set forth in claim 1 further comprising authenticating one or more of the client systems before providing access to the imaging system.

5. The method as set forth in claim 4 wherein the authenticating further comprises:
receiving a request to access the imaging system from one of the client system;
determining if the received request is during a scheduled authorization period for the requesting client system; and
granting the received request to requesting client system if during the scheduled authorization period.

6. The method as set forth in claim 1 further comprising restricting receipt of the instructions at the imaging system to the received instructions from one of the client systems.

7. The method as set forth in claim 6 further comprising adjusting the restriction to receive the instructions from one of the client systems to another one of the client systems.

8. The method as set forth in claim 1 further comprising:
determining an available bandwidth for the providing of the images; and
adjusting a frame rate for the providing of the images based on the determined bandwidth.

9. The method as set forth in claim 1 wherein one of the operations comprises manipulating the object to at least one other position.

10. The method as set forth in claim 1 wherein one of the operations comprises making one or more adjustments to lighting of the object.

11. The method as set forth in claim 1 wherein one of the operations comprises adjusting one or more image controls of the imaging system.

12. A computer readable medium having stored thereon instructions for remote imaging comprising machine executable code which when executed by at least one processor, causes the processor to perform steps comprising:
providing in substantially real time one or more images of an object captured with an imaging system to one or more client systems at one or more locations remote from the imaging system;
receiving in substantially real time from at least one of the client systems one or more instructions to interact with the imaging system; and
executing one or more operations at the imaging system in response to the instructions, wherein the providing provides one or more updated images to the client systems in response to the execution of the operations.

13. The medium as set forth in claim 12 further comprising receiving a dynamically established bounding region around the object, wherein the executing the one or more instructions is constrained by the bounding region.

14. The medium as set forth in claim 13 wherein the bounding region is defined in three dimensions.

15. The medium as set forth in claim 12 further comprising authenticating one or more of the client systems before providing access to the imaging system.

16. The medium as set forth in claim 15 wherein the authenticating further comprises:
receiving a request to access the imaging system from one of the client system;
determining if the received request is during a scheduled authorization period for the requesting client system; and
granting the received request to requesting client system if during the scheduled authorization period.

17. The medium as set forth in claim 12 further comprising restricting receipt of the instructions at the imaging system to the received instructions from one of the client systems.

18. The medium as set forth in claim 17 further comprising adjusting the restriction to receive the instructions from one of the client systems to another one of the client systems.

19. The medium as set forth in claim 12 further comprising:
determining an available bandwidth for the providing of the images; and
adjusting a frame rate for the providing of the images based on the determined bandwidth.

20. The medium as set forth in claim 12 wherein one of the operations comprises manipulating the object to at least one other position.

21. The medium as set forth in claim 12 wherein one of the operations comprises making one or more adjustments to lighting of the object.

22. The medium as set forth in claim 12 wherein one of the operations comprises adjusting one or more image controls of the imaging system.

23. A system for remote imaging, the system comprising:
an imaging system that captures one or more images of an object;
a transceiver system that in substantially real time provides the images to one or more client systems at one or more remote locations and receives from at least one of the client systems one or more instructions to interact with the imaging system; and
an image processing system that executes one or more operations at the imaging system in response to the instructions, wherein the transceiver system provides one or more updated images to the client systems in response to the execution of the operations.

24. The system as set forth in claim 23 wherein the image processing system receives a dynamically established bounding region around the object from the imaging system, wherein the image processing system the execution of the one or more instructions is constrained by the bounding region.

25. The system as set forth in claim 24 wherein the bounding region is defined in three dimensions.

26. The system as set forth in claim 23 wherein the image processing system authenticates one or more of the client systems before providing access to the imaging system.

27. The system as set forth in claim 26 wherein the transceiver system receives a request to access the imaging system from one of the client system, the image processing system determines if the received request is during a scheduled authorization period for the requesting client system and grants the received request to requesting client system if during the scheduled authorization period.

28. The system as set forth in claim 23 wherein the image processing system restricts receipt of the instructions to the received instructions from one of the client systems.

29. The system as set forth in claim 28 wherein the image processing system adjusts the restriction to receive the instructions from one of the client systems to another one of the client systems.

30. The system as set forth in claim 23 wherein the image processing system determines an available bandwidth for providing of the images and adjusts a frame rate for the providing of the images based on the determined bandwidth.

31. The system as set forth in claim 23 further comprises a manipulation system that manipulates the object to at least one other position in response to the execution of one of the operations by the image processing system.

32. The system as set forth in claim 23 further comprising a lighting system that makes one or more adjustments to lighting of the object in response to the execution of one of the operations by the image processing system.

33. The system as set forth in claim 23 further comprising an adjustment system that adjusts one or more image controls of the imaging system in response to the execution of one of the operations by the image processing system.

34. A method for remotely focusing an imaging system, the method comprising:
superimposing a favorite image over a selected image;
selecting one of the superimposed images based on a comparison of one or more aspects of the favorite image and the selected image; and
setting a focus of the imaging system based on one or more settings used for capturing the selected one of the superimposed images.

35. The method as set forth in claim 34 further comprising determining if another selected image should be superimposed over the selected one of the superimposed images, wherein the superimposing, the selecting and the determining are repeated with the another selected image and the selected one of the superimposed images if the determining determines the another selected image should be selected.

36. The method as set forth in claim 34 wherein the one or more aspects comprise focus, depth of field, lighting, and cropping.

37. A system for remotely focusing an imaging system, the system comprising:
a display system which superimposing and enables manipulation of a favorite image over a selected image;
a selection system which selects one of the superimposed images based on a comparison of one or more aspects in the favorite image and the selected image; and
a focus adjustment system that sets a focus of an imaging system based on one or more settings used for capturing the selected one of the superimposed images.

38. The system as set forth in claim 37 wherein the selection system determines if another selected image should be superimposed over the selected one of the superimposed images, wherein the selection system selects one of the favorite image and another selected image based on a comparison of one or more aspects in the favorite image and the another selected image if the selection system determines another image should be selected.

39. The system as set forth in claim 37 wherein the one or more aspects comprise focus, depth of field, lighting, and cropping.
